(19) United States
(12) Patent Application Publication
(10) Pub. No.: US 2007/0069857 A1
(43) Pub. Date: Mar. 29, 2007

(54) Methods, apparatus and systems for reading recorded information stored in RFID tags

(76) Inventors: Kenji Utaka, Hitachi (JP); Masataka Aoki, Hitachi (JP); Kenji Araki, Mito (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/514,208

(22) Filed: Sep. 1, 2006

(30) Foreign Application Priority Data
Sep. 28, 2005 (JP) 2005-281480

(51) Int. Cl. H04Q 5/22

(52) U.S. Cl. 340/10.1

(57) ABSTRACT

A viewer qualification is stored in an RFID tag of a reader operator who is a user of the tag information reader and a viewer qualification range defined for each piece of article information depending on confidentiality of the article is stored in the article tag along with multiple pieces of article information. The wireless communication part in the tag information reader obtains the viewer qualification from the tag of the user, obtains the multiple pieces of article information and the viewer qualification range from the article tag, and stores them in a storage area. The information extracting part extracts the article information a viewer qualification range of which covers the viewer qualification from the storage area, and passes it to a display part for displaying it.

### BACKGROUND OF THE INVENTION

1. Field of the Invention

The present invention relates to a tag information reader for reading one or more pieces of article information stored in an RFID tag attached to an article, a tag system having the same, and a method for reading the tag information using the tag information reader.

2. Description of Related Art

There has been a method for managing an article by a wireless communications tag referred to as a radio frequency identification (RFID) attached to the article, from which article information is read by a tag information reader.

Techniques relating to such an RFID tag and tag information reader include, for example, those described in JP-A-2000-306051 and JP-A-2002-236891.

The technique described in JP-A-2000-306051 relates to a tag information reader, which is provided with a printing mechanism for printing the information obtained from an RFID tag through wireless communication.

The technique described in JP-A-2002-236891 relates to an RFID tag, which is provided with a display function for displaying the information stored in a memory in the tag.

These conventional techniques, however, allow anyone to view the information stored in the RFID tag, and suffer from problems of information leakage and the like that are not manageable.

### SUMMARY OF THE INVENTION

The present invention has been made in view of the foregoing conventional problems, and it is an object of the invention to provide a method, apparatus and system for reading recorded information stored in RFID tags, in which the viewability of the information stored in the RFID tags can be regulated.

The invention relating to a method for reading tag information to solve the foregoing problems is characterized by a method for reading the tag information wherein one or more pieces of article information stored in an RFID tag (hereinafter referred to as an article tag) attached to an article are read using a tag information reader, including: storing a viewer qualification in a reader operator's RFID tag (hereinafter referred to as a reader operator tag), the reader operator being a user of the tag information reader; storing a viewer qualification range in the article tag along with the one or more pieces of article information, the viewer qualification range defined for each piece of article information depending on confidentiality of the article; and in the tag information reader, obtaining the viewer qualification from the reader operator tag through wireless communication, obtaining the one or more pieces of article information and the viewer qualification range defined for each piece of article information from the article tag through wireless communication, extracting one or more pieces of article information for which a viewer qualification range containing the viewer qualification is defined, and outputting the extracted one or more pieces of article information.

Further, the invention relating to a tag information reader to solve the foregoing problems is characterized by a tag information reader for reading information stored in an RFID tag, including: wireless communication means for wirelessly communicating with the RFID tag to obtain the information stored in the RFID tag; storage means for storing the information obtained by the wireless communication means; information extracting means for extracting a specific piece of information from the information stored in the storage means; and output means for outputting the information extracted by the information extracting means, wherein, after the wireless communication means obtains a viewer qualification stored in a reader operator's RFID tag (hereinafter referred to as a reader operator tag) and one or more pieces of article information and the viewer qualification range defined for each piece of article information depending on confidentiality of the article stored in an RFID tag (hereinafter referred to as an article tag) attached to an article and stores them in the storage means, the information extracting means extracts one or more pieces of article information a viewer qualification range of which covers the viewer qualification obtained from the reader operator tag.

Here, the tag information reader may be characterized in that, if an article viewing condition defined for each of one or more pieces of article information stored in the article tag is stored in the storage means, the information extracting means does not extract one or more pieces of article information for which the article viewing condition is defined until information that satisfies the article viewing condition is stored in the storage means, and the article viewing condition is defined according to a nature of the article having the article tag attached and is a condition distinct from the viewer qualification range, the article viewing condition being stored in the article tag and obtained by the wireless communication means to store in the storage means.

Further, the invention relating to a tag system to solve the foregoing problems is characterized by including the tag information reader, the reader operator tag, and the article tag as described above.

According to the invention, article information in an article tag attached to an article may be viewed only when a viewer qualification range defined depending on confidentiality of the article contains a viewer qualification for the reader operator, so that information leakage and the like may be prevented.

Other objects, features and advantages of the invention will become apparent from the following description of the embodiments of the invention taken in conjunction with the accompanying drawings.

### BRIEF DESCRIPTION OF THE DRAWINGS

FIG. 1 illustrates a configuration of an RFID tag system according to an embodiment of the invention;

FIG. 2 is a circuit block diagram of the RFID tag system according to the embodiment of the invention;

FIG. 3 is a functional block diagram of the RFID tag system according to the embodiment of the invention;

FIGS. 4A and 4B illustrate information stored in a piping tag (article tag) according to the embodiment of the invention;

FIGS. 5A and 5B illustrate information stored in a reader operator tag according to the embodiment of the invention;

FIG. 6 is a flow chart illustrating the operation of the tag information read/write device during the read of information according to the embodiment of the invention; and

FIG. 7 is a flow chart illustrating the operation of the tag information read/write device during the write of information according to the embodiment of the invention.

### DESCRIPTION OF THE EMBODIMENTS

Hereafter, an RFID tag system according to the invention will now be described with reference to the drawings.

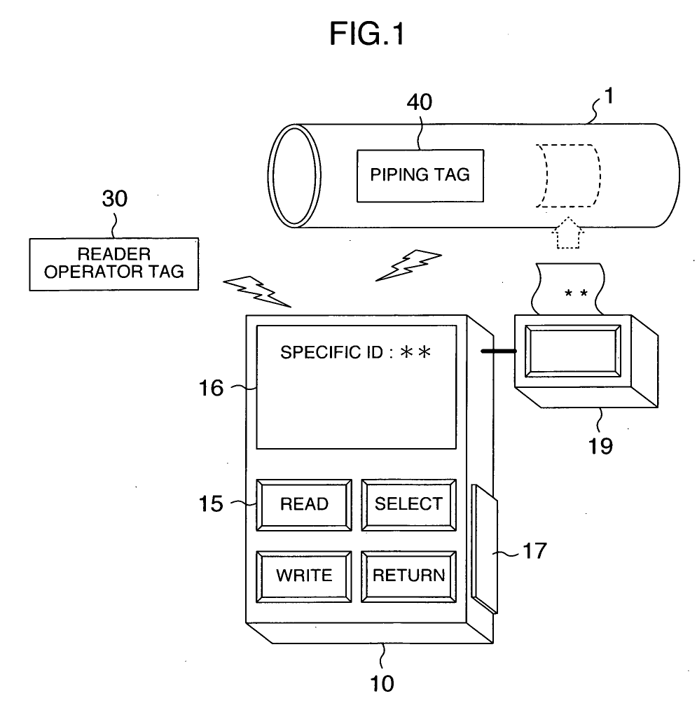

As shown in FIG. 1, the RFID tag system according to the embodiment is provided with a tag information read/write device 10 for reading and writing information to and from an RFID tag, a printer 19 for use in printing according to an instruction from the tag information read/write device 10, a reader operator tag 30 possessed by a user of the tag information read/write device 10, and a piping tag 40 attached to an article, or a pipe 1.

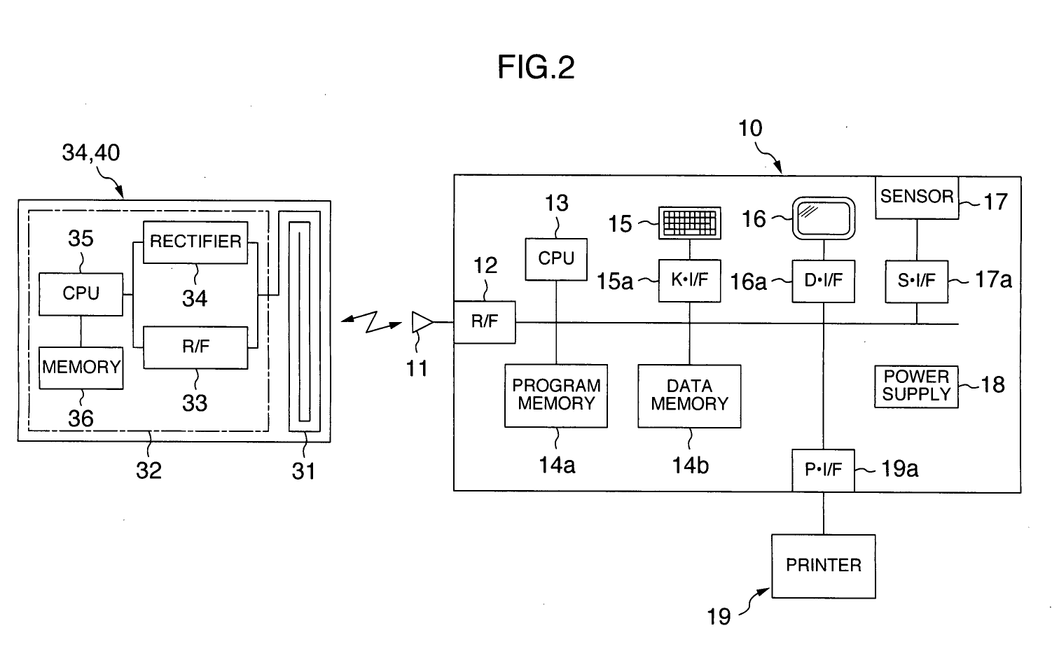

As shown in FIG. 2, the tag information read/write device 10 is provided with an antenna 11, an RF circuit 12 that performs modulation, demodulation, and the like, a CPU 13 that performs various operations, a program memory 14a that stores a program executed by the CPU 13, a data memory 14b that stores various data, a variety of key switches 15, a key switch interface 15a, a display 16, a display interface 16a, a touch sensor 17, a sensor interface 17a, a power supply 18, and a printer interface 19a. As shown in FIG. 1, the touch sensor 17 is provided on the side face of a rectangular casing of the tag information read/write device 10.

Both the reader operator tag 30 and the piping tag 40 are an RFID tag, and provided with a flat coil-shaped antenna 31, and an IC chip 32. The IC chip 32 has a rectifier 34, an RF circuit 33 that performs modulation, demodulation, and the like, a CPU 35 that executes various processes, and a memory 36. A communication counterpart for these RFID tags 30 and 40 generates a radio frequency electromagnetic field. The radio frequency electromagnetic field is absorbed through the antenna 31 of these RFID tags 30 and 40, and rectified in the rectifier 34 for use as a DC power source for driving each circuit in the IC chip 32. The memory 36 is, for example, a nonvolatile, electrically readable/writable memory such as a NAND flash ROM. The CPU 35 reads and writes information to and from the memory 36 depending on the content of external wireless communication.

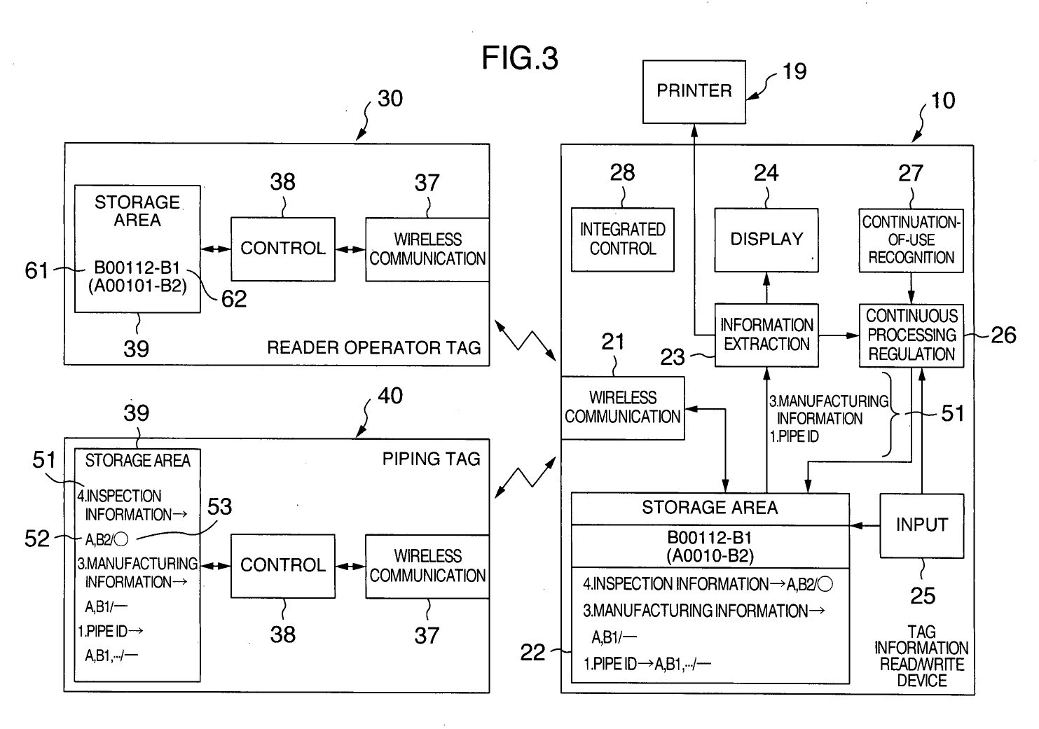

As shown in FIG. 3, the tag information read/write device 10 includes, in terms of the functionality, a wireless communication part 21 that wirelessly communicates with the RFID tags 30 and 40, a storage area 22 that stores information obtained from the RFID tags 30 and 40, an information extracting part 23 that extracts only a specific piece of information from the information stored in the storage area 22, a display part 24 that displays the information extracted by the information extracting part 23, an input part 25 used by a user to input instructions and the like into the device 10, a continuous processing regulatory part 26 that regulates continuous reads of information from multiple article tags 40 for each viewer qualification obtained one at a time from the reader operator tag 30, a continuation-of-use recognizing part 27 that recognizes continuation of use of the device 10, and an integrated control part 28 that integrally controls all functions described above.

In functional components described above, the wireless communication part 21 consists of the antenna 11 and RF circuit 12 as shown in FIG. 2, and the information extracting part 23, the continuous processing regulatory part 26, and the integrated control part 28 are respectively accomplished by the program memory 14a and the CPU 13 that executes the program stored in the program memory 14a. In addition, the display part 24 has the display 16 and display interface 16a, the input part 25 has the key switches 15 and key switch interface 15a, and the continuation-of-use recognizing part 27 has the touch sensor 17 and sensor interface 17a: these are also accomplished by the program memory 14a and CPU 13. The storage area 22 consists of the data memory 14b.

The reader operator tag 30 and the piping tag 40 each has, in terms of the functionality, a wireless communication part 37, a storage area 39, and a control part 38 that controls them. The wireless communication part 37 consists of the antenna 31 and RF circuit 33 as shown in FIG. 2, and the storage area 39 consists of the memory 36. In addition, the control part 38 consists of the memory 36 and the CPU 35 that executes the program stored in the memory 36.

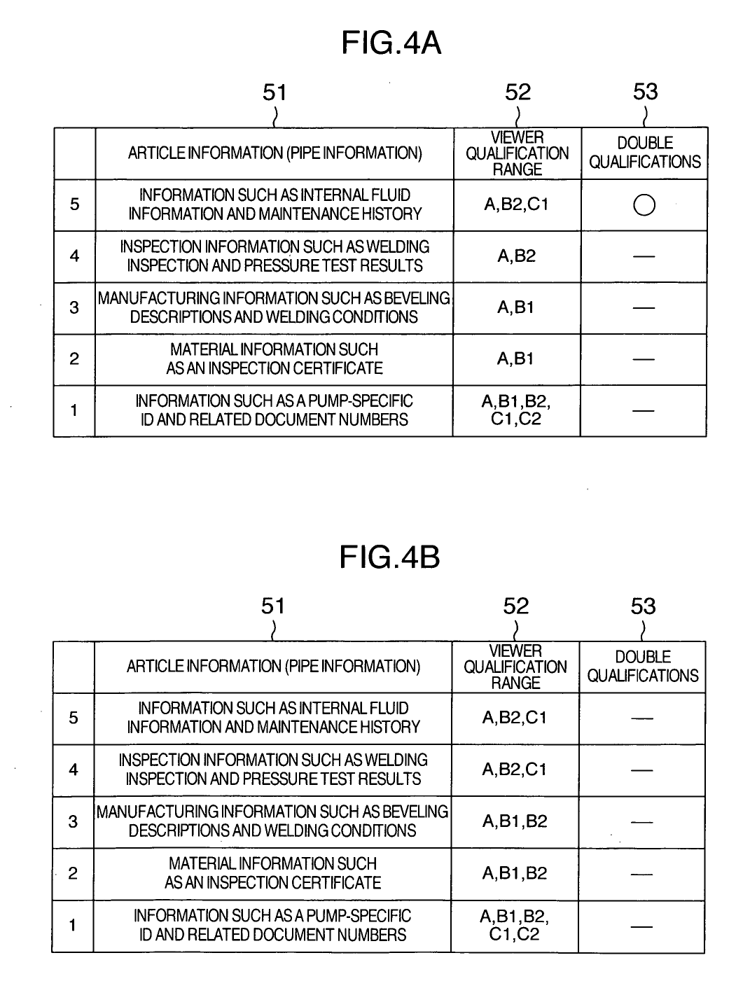

As shown in FIGS. 4A and 4B, the storage area 39 of the piping tag 40 stores multiple pieces of article information (piping information) 51 divided into multiple items 1 to 5, a viewer qualification range 52 defined for each piece of article information, and an article viewing condition, “whether or not double qualifications are required,” 53 defined for each piece of article information. The multiple pieces of article information 51 include, for example, article information for item 1 such as a pipe-specific ID for an article, or a pipe, and related document numbers serving as a table of contents, article information for item 2 such as material information including an inspection certificate and the like, article information for item 3 such as manufacturing information including beveling descriptions, welding conditions, and the like, article information for item 4 such as inspection information including welding inspection results, pressure test results, and the like, and article information for item 5 such as internal fluid information and maintenance history. The viewer qualification range 52 is defined for the article information 51 for each item, as described above. The viewer qualification range is defined depending on confidentiality of the article, in other words, openness of article information. For example, in case of information in the piping tag shown in FIG. 4A, all qualifications are defined for the item 1, qualifications of A and B1 are defined for the items 2 and 3, qualifications of A and B2 are defined for the item 4, and qualifications of A, B2, and C1 are defined for the item 5. In addition, it is specified that the double qualifications are required for the item 5. The term “double qualifications” means that viewer qualifications for two persons are required. In case of information in the piping tag shown in FIG. 4B, all qualifications are defined for the item 1, qualifications of A, B1, and B2 are defined for the items 2 and 3, and qualifications of A, B2, and C1 are defined for the items 4 and 5. In addition, it is specified that double qualifications are not required for any item.

Although a piping tag is here described by way of illustration, the invention is not limited to it: for example, when the article is a pump, it is conceivable that article information for item 1 may be a pump-specific ID and related document numbers serving as a table of contents, article information for item 2 may be material information of pump components, article information for item 3 may be specification information for the pump, article information for item 4 may be various inspection information for the pump, and article information for item 5 may be internal fluid information and maintenance history.

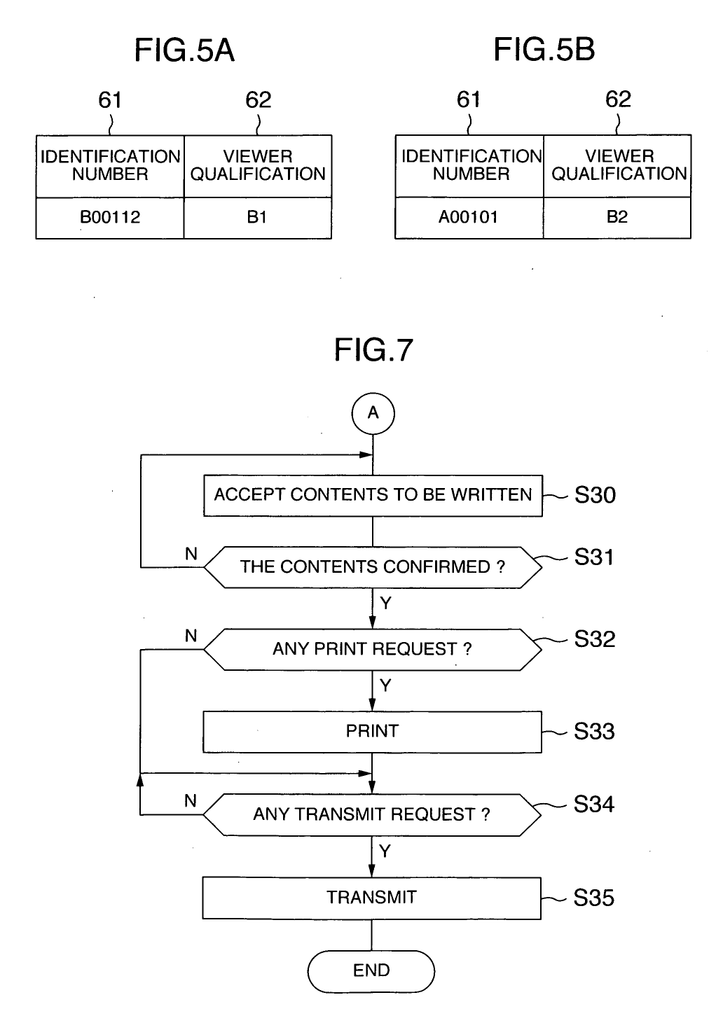

As shown in FIGS. 5A and 5B, the storage area 39 in the reader operator tag 30 stores an identification number 61 for the reader operator, and a viewer qualification 62. In the embodiment, there are viewer qualifications A, B1, B2, C1, and C2 as shown in FIGS. 4A and 4B. The qualification A is granted to, for example, a chief administrator who generally manages from construction to operation, the qualification B1 is granted to, for example, a construction worker, and the qualification B2 is granted to, for example, an operator.

The information is written by the tag information read/write device 10 into the storage areas 39 of the reader operator tag 30 and piping tag 40 as described above. Writes into the storage area 39 of the piping tag 40 will be described below with reference to a flow chart shown in FIG. 7.

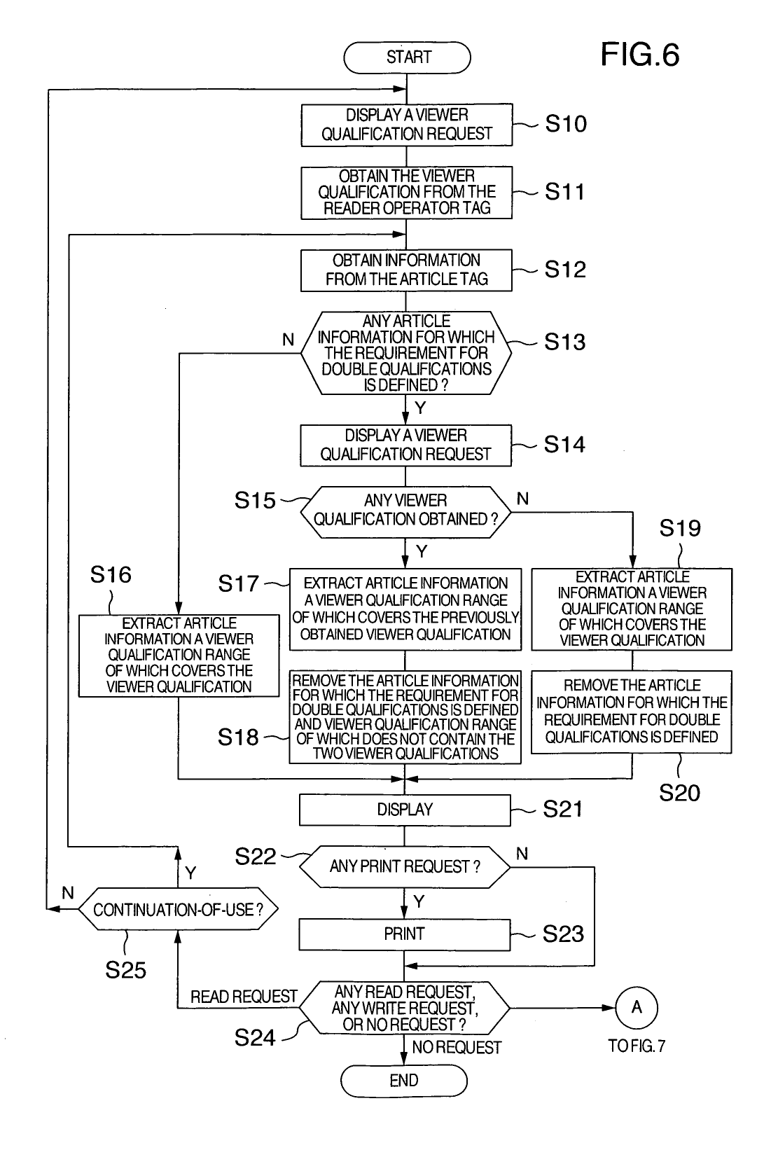

The operation of the tag information read/write device 10 in reading information stored in the piping tag 40 will now be described with reference to a flow chart shown in FIG. 6.

When the tag information read/write device 10 turns on, the integrated control part 28 causes the display part 24 to display a viewer qualification request (S10). In this case, the display part 24 displays a message such as “Read in your tag information.” The reader operator who sees it brings the tag information read/write device 10 close to the reader operator tag 30, and allows the tag information read/write device 10 to read the viewer qualification stored in the reader operator tag 30 (S11). At this time, the device 10 outputs, from the wireless communication part 21, a request for transmitting a reader operator identification number and the viewer qualification. Upon receiving the request, in the reader operator tag 30, the control part 38 reads the reader operator identification number and the viewer qualification from the storage area 39 and causes the wireless communication part 37 to transmit them. Upon receiving the reader operator identification number and the viewer qualification, the wireless communication part 21 in the tag information read/write device 10 stores them in the storage area 22.

Once the viewer qualification or the like is obtained from the reader operator tag 30 (S11), the tag information read/write device 10 displays a request for reading information from the piping tag 40 in the display part 24, and obtains the information from the article tag 40 in a similar way that the viewer qualification is read (S12).

Once the information from the reader operator tag 30 and piping tag 40 is stored in the storage area 22 of the tag information read/write device 10, the information extracting part 23 in the tag information read/write device 10 determines whether or not there is any article information for which the requirement for double qualifications is defined among multiple pieces of article information obtained from the article tag 40 (S13).

For example, the piping tag 40 has the information shown in FIG. 4A stored therein, and because the requirement for double qualifications is defined for article information for item 5 among the multiple pieces of article information 51, the information extracting part 23, which once receives the information, determines that there is article information for which the requirement for double qualifications is defined. Similarly, the piping tag 40 has the information shown in FIG. 4B stored therein, and because the requirement for double qualifications is not defined for any of the multiple pieces of article information 51, the information extracting part 23, which once receives the information, determines that there is no article information for which the requirement for double qualifications is defined.

If it is determined that there is no article information for which the requirement for double qualifications is defined, the information extracting part 23 extracts article information a viewer qualification range of which covers the viewer qualification for the reader operator from multiple pieces of article information stored in the storage area 22 (S16). For example, if the viewer qualification for the reader operator is “B1”, article information for items 1 to 3, which contain “B1” in the viewer qualification ranges 52, is extracted from the article information 51 shown in FIG. 4B.

If the information extracting part 23 determines that there is article information for which the requirement for double qualifications is defined in step 13, it informs the integrated control part 28 of the determination and the integrated control part 28 causes the display part 24 to display the viewer qualification request (S14).

The information extracting part 23 determines whether or not another viewer qualification has been stored in the storage area 22, or whether or not another viewer qualification has been obtained (S15), and if it is determined that another viewer qualification has been obtained, it first extracts article information a viewer qualification range of which covers the previously obtained viewer qualification from multiple pieces of article information stored in the storage area 22 (S17). Subsequently, the article information for which the requirement for double qualifications is defined and whose viewer qualification range does not contain the two viewer qualifications is removed from the article information extracted in step 17 (S18). For example, if the previously obtained viewer qualification is “B2”, article information for items 1, 4 and 5, which contain “B2” in the viewer qualification ranges 52, is extracted from the article information shown in FIG. 4A in step 17. If the subsequently obtained viewer qualification is any of “A”, “B2”, and “C1”, in step 18, the article information for item 5 for which the requirement for double qualifications is defined is not removed from the article information extracted in step 17 because its viewer qualification range contains the two qualifications; in this case the previous “B2” qualification along with any of “A”, “B2”, and “C1”. If the subsequently obtained viewer qualification is any of “B1” and “C2”, in step 18, the article information for item 5 for which the requirement for double qualifications is defined is removed from the article information extracted in step 17 because its viewer qualification range does not contain the two qualifications; in this case the previous “B2” qualification along with any of “B1” and “C2”.

If the information extracting part 23 determines that another viewer qualification is not obtained in step 15, it extracts article information a viewer qualification range of which covers the viewer qualification obtained in step 11 from multiple pieces of article information stored in the storage area 22 as in step 17 (S19). Subsequently, article information for which the requirement for double qualifications is defined is removed from the article information extracted in step 19 (S20). For example, if the previously obtained viewer qualification is “B2”, article information for items 1, 4 and 5, which contain “B2” in the viewer qualification ranges 52, is extracted from the article information shown in FIG. 4A in step 20. In step 19, the article information for item 5 for which the requirement for double qualifications is defined is removed from the article information extracted in step 20.

Once one or more pieces of article information are extracted in processes of steps 16 to 20, these pieces of article information are passed to the display part 24 and displayed on the display part 24 (S21). The display part 24 displays the one or more pieces of article information in a hierarchical way. Specifically, article information for item 1, which is displayed for any viewer qualification, such as a pipe-specific ID and related document numbers serving as a table of contents is first displayed, and then, article information for other items are displayed depending on instructions from the reader operator, or the user. Even when the user instructs the device to display article information for other items, however, denial of display for the items such as “Your viewer qualification is ineligible for displaying item X information” is displayed if article information for the items are not extracted in the processes of steps 16 to step 20. Alternatively, the denial of display may be accomplished by, for example, displaying unviewable items in a thin color and disabling them from being selected while related document numbers serving as a table of contents are displayed.

The integrated control part 28 next determines whether or not there has been a print request from the user manipulating the input part 25 (S22). Upon the print request, the integrated control part 28 sends print data of article information being displayed to the printer 19 to print the article information being displayed (S23).

If it is determined that there is no print request in step 22, or when printing is completed after the print request has been received, the integrated control part 28 determines whether there is another request for reading article information from the user manipulating the input part 25, whether there is a request for writing article information, or whether there are neither of requests (S23).

Upon a read request, the continuation-of-use recognizing part 27 determines whether or not the device 10 has been continuously used since the viewer qualification in the reader operator tag has been obtained in step 11 until this time (S25). The continuation-of-use of the device 10 here indicates that the initial reader operator has continued to use the device 10 without transfer of the device 10 to a third party since the viewer qualification has been obtained from the reader operator tag in step 11 until this time. If it is determined that the device 10 has not been continuously used, the continuous processing regulatory part 26 erases the viewer qualification stored in the storage area 22, returns to step 10 and causes the display part 24 to display the viewer qualification request. As a result, continuous obtainment of information from multiple piping tags 40 is regulated for each viewer qualification obtained one at a time. Even if article information or the like is enabled to be continuously obtained from multiple piping tags 40, article information obtained in and after the second round is not extracted by the information extracting part 23 because the viewer qualification has been erased in the storage area 22.

If it is determined that the device 10 has been continuously used until this time in step 25, the continuous processing regulatory part 26 deregulates continuous processing: that is, it does not erase the viewer qualification stored in the storage area 22, returns to step 12 and causes the display part 24 to display the request for obtaining (reading) article information or the like from the piping tag 40, and the article information or the like is obtained.

Upon a write request in step 24, the input part 25 accepts contents to be written, continuing with step 30 in FIG. 7. The write request is required, for example, when a write process has never been performed for article information relating to the item, leaving a blank display in step 21, or when written contents are updated once the write process has been performed. Writes of information into the piping tag 40 are allowed here, if there is a viewer qualification for information in the piping tag 40; that is, a qualification for writing information into the piping tag 40 is the same as the viewer qualification for information in the piping tag 40; however, they may be different qualifications. In this case, for example, the write qualification may be a higher-level qualification than the viewer qualification or double qualifications may be requested, so that it can be determined whether or not the writes may be allowed with the qualification stored in the storage area 22 at this time upon the write request, and if it is determined that the writes are not allowed, a qualification may otherwise be requested.

Once the integrated control part 28 accepts a confirmation of the contents to be written from the input part 25 (S31), it determines whether or not there has been a print request from the input part 25 (S32). Upon the print request, the integrated control part 28 sends print data of the confirmed contents to be written to the printer 19 to print them (S33). If it is determined that there is no print request in step 32, or when printing is completed after the print request has been received, the integrated control part 28 determines whether there is a transmit request from the input part 25 (S23). Upon a transmit request, the integrated control part 28 passes the contents to be written to the wireless communication part 21 to transmit them. Once the wireless communication part 37 in the piping tag 40 receives the contents to be written, the control part 38 stores the contents to be written into the storage area 38. The information to be written transmitted from the device 10 to the piping tag 40 may include the identification number of the user obtained in step 11 along with the contents actually inputted by the user, so that the person who writes information into the piping tag 40 can be identified later.

In this way, once the contents to be written are transmitted, the sequence of processes in the device 10 is completed. If it is determined that there are neither of requests in step 24, the sequence of processes in the device 10 is also completed.

As described above, in the embodiment, article information in an article tag 40 attached to an article may be viewed only when a viewer qualification range defined depending on confidentiality of the article contains a viewer qualification for the reader operator, so that information leakage and the like may be prevented. When an article viewing condition is defined, information leakage and the like may further be prevented.

Although the embodiment is illustrated for the case where the article tag is attached to a component or equipment in a plant, the invention is not limited to it, and it will easily be appreciated that a viewer qualification and the like may be specified to manage article tag information in a similar way as described above in cases where it is desired that a certain article may have an article tag attached thereto and information stored in the article tag may be managed.

It should be further understood by those skilled in the art that although the foregoing description has been made on embodiments of the invention, the invention is not limited thereto and various changes and modifications may be made without departing from the spirit of the invention and the scope of the appended claims.

1. A method for reading a tag information wherein one or more pieces of article information stored in an RFID tag (hereinafter referred to as an article tag) attached to an article are read using a tag information reader, comprising the steps of:
storing a viewer qualification in a reader operator's RFID tag (hereinafter referred to as a reader operator tag), the reader operator being a user of the tag information reader;
storing a viewer qualification range in the article tag along with the one or more pieces of article information, the viewer qualification range defined for each piece of article information depending on confidentiality of the article; and
in the tag information reader, obtaining the viewer qualification from the reader operator tag through wireless communication, obtaining the one or more pieces of article information and the viewer qualification range defined for each piece of article information from the article tag through wireless communication, extracting one or more pieces of article information a viewer qualification range of which covers the viewer qualification obtained from the reader operator tag, and outputting the extracted one or more pieces of article information.

2. The method for reading a tag information according to claim 1, further comprising the steps of:
storing, in the article tag, an article viewing condition that is defined according to a nature of the article having the article tag attached and is a condition distinct from the viewer qualification range, the article viewing condition defined for each of one or more pieces of article information stored in the article tag; and
in the tag information reader, when obtaining the viewer qualification from the reader operator tag through wireless communication, obtaining the one or more pieces of article information and the viewer qualification range and the article viewing condition defined for each piece of article information from the article tag through wireless communication, extracting one or more pieces of article information that satisfy the article viewing condition and a viewer qualification range of which covers the viewer qualification, and outputting the extracted one or more pieces of article information.

3. A tag information reader for reading information stored in an RFID tag, comprising:
wireless communication means for wirelessly communicating with the RFID tag to obtain the information stored in the RFID tag;
storage means for storing the information obtained by the wireless communication means;
information extracting means for extracting a specific piece of information from the information stored in the storage means; and
output means for outputting the information extracted by the information extracting means, wherein, after the wireless communication means obtains a viewer qualification stored in a reader operator's RFID tag (hereinafter referred to as a reader operator tag) and one or more pieces of article information and the viewer qualification range defined for each piece of article information depending on confidentiality of the article stored in an RFID tag (hereinafter referred to as an article tag) attached to an article and stores them in the storage means, the information extracting means extracts one or more pieces of article information a viewer qualification range of which covers the viewer qualification obtained from the reader operator tag.

4. The tag information reader according to claim 3, wherein if an article viewing condition defined for each of one or more pieces of article information stored in the article tag is stored in the storage means, the information extracting means does not extract any article information for which the article viewing condition is defined until information that satisfies the article viewing condition is stored in the storage means, and
the article viewing condition is defined according to a nature of the article having the article tag attached and is a condition distinct from the viewer qualification range, the article viewing condition being stored in the article tag and obtained by the wireless communication means to store in the storage means.

5. The tag information reader according to claim 4, wherein the article viewing condition is that the viewer qualifications for a predefined number of persons are stored in the storage means.

6. The tag information reader according to claim 3, further comprising continuous processing regulatory means for regulating continuous obtainment of information by the wireless communication means from a plurality of article tags or regulating continuous extraction of information obtained from each of the plurality of article tags by the information extracting means from the storage means, for each viewer qualification obtained one at a time.

7. The tag information reader according to claim 6, further comprising continuation-of-use recognizing means for recognizing continuation of use by a same reader operator, wherein the continuous processing regulatory means deregulates the continuous processing when the continuation of use by a same reader operator is recognized by the continuation-of-use recognizing means.

8. The tag information reader according to claim 3, wherein the output means has print means for printing information extracted by the information extracting means or transmission means for sending the information extracted by the information extracting means to print means.

9. A tag system comprising:
a tag information reader according to claim 3;
the reader operator tag; and
the article tag.
